(19) United States
(12) Patent Application Publication
(10) Pub. No.: US 2004/0024629 A1
(43) Pub. Date: Feb. 5, 2004

(54) Methods and apparatus for project management

(76) Inventors: Jack Reese Kirby JR., Salem, VA (US); Janice Ellen Frick Burr, Roanoke, VA (US); Stephen Sterling Fisk, Roanoke, VA (US); Edward Buchanan Wagstaff, Salem, VA (US); John Douglas D'Atre, Salem, VA (US)

Correspondence Address: John S. Beulick, Armstrong Teasdale LLP, One Metropolitan Sq., Suite 2600, St. Louis, MO, 63102, US

(21) Appl. No.: 10/210,923

(22) Filed: Aug. 2, 2002

(51) Int. Cl. G06F 17/60

(52) U.S. Cl. 705/8

(57) ABSTRACT

A method for project management using a project management tool and a network is provided. The project management tool includes a database and at least one client system configured to communicate with the network and the project management tool. The method includes entering a project time entry into the database using the at least one client system and the network, storing the project time entry in the database, and allowing a user to at least one of view, modify, delete, and report the project time entry using the at least one client system and the network.

### BACKGROUND OF THE INVENTION

The present invention relates generally to project management, and more particularly to methods and apparatus for tracking project time.

Effective project management is critical to the success of a business entity. Delays in the introduction of a product to market can adversely affect the profitability of the business entity because competitors have more time to place a similar item on the market and because revenue generation is at least partially dependent on the release of the product to market. Slippage in schedules can also result in the development of two products requiring the same resource at the same time, thereby necessitating further delay in the development of one of them.

Project management allows the business entity to identify the tasks that need to be completed for the development of a given product, estimate accurately the time required for each of those tasks to be completed, and identify which resources will be needed to accomplish those tasks. Estimates of time, costs, and resources arise from the experience of the business entity in developing similar products. Thus, accurate tracking of such information enables accurate future estimates of those quantities for new products.

In a small business entity, knowledge of the costs, time, and resources to complete previous projects is obtained by consultation with employees of the company, who often are all at one site, paper time recording, which can incur error, or ‘flat’ computer program recording. In larger business entities, direct inquiry of employees becomes progressively less useful. Employees who worked on a given project may be scattered across the globe, and/or may have left the corporation since the project was undertaken. Indeed, in some instances there may be relatively little recollection of the project at all. Information that is beneficial to assist in the planning of new products is sometimes difficult to obtain, and may be lost entirely. In addition, known project tracking systems only include a ‘flat’ list of projects, and only allow a financial summation for tracking project time and man-hours. Furthermore, in known systems details of a particular time record can only be captured with highly variable notes.

### BRIEF DESCRIPTION OF THE INVENTION

In one aspect, a method for project management using a project management tool and a network is provided. The project management tool includes a database and at least one client system configured to communicate with the network and the project management tool. The method includes entering a project time entry into the database using the at least one client system and the network, storing the project time entry in the database, and allowing a user to at least one of view, modify, delete, and report the project time entry using the at least one client system and the network.

In another aspect, a project management tool that includes at least one computer configured as a server that contains a centralized database, and at least one client system connected to the server through a network is provided. The client system is configured with a browser. The centralized database contains at least one project time entry. The server is configured to store the at least one project time entry in the database, and allow a user to at least one of view, modify, delete, and report the at least one project time entry using the at least one client system and the network.

In another aspect, a computer program embodied on a computer readable medium for managing projects is provided. The program includes a code segment that maintains a database by adding, deleting and updating information relating to at least one project, stores at least one project time entry in the database, and enables a user to at least one of view, modify, delete, and report the at least one project time entry through a client system.

### BRIEF DESCRIPTION OF THE DRAWINGS

FIG. 1 is a simplified block diagram illustrating an example embodiment of a project management tool for tracking project time.

FIG. 2 is an expanded version block diagram of an example embodiment of server architecture of a project management tool.

FIG. 3 is a flowchart illustrating example processes utilized by a project management tool.

FIG. 4 is an example embodiment of a user interface displaying a home page within a project management tool.

FIG. 5 is an example embodiment of a user interface displaying a project page within a project management tool.

FIG. 6 is an example embodiment of a user interface displaying a work page within a project management tool.

FIG. 7 is an example embodiment of a user interface displaying a user page within a project management tool.

FIG. 8 is an example embodiment of a user interface displaying a user page with an expanded tree-like structure of users within a project management tool.

FIG. 9 is an example embodiment of a user interface displaying a group page within a project management tool.

FIG. 10 is an example embodiment of a user interface displaying a group page with an expanded tree-like structure of groups within a project management tool.

FIG. 11 is an example embodiment of a user interface displaying an update page within a project management tool.

FIG. 12 is an example embodiment of a user interface displaying a node types page within a project management tool.

FIG. 13 is an example embodiment of a user interface displaying an edit work page within a project management tool.

FIG. 14 is an example embodiment of a user interface displaying a quick voucher page within a project management tool.

FIG. 15 is an example embodiment of a user interface displaying a newly added voucher page within a project management tool.

FIG. 16 is an example embodiment of a user interface displaying a reports page within a project management tool.

FIG. 17 is an example embodiment of a user interface displaying a view page within a project management tool.

FIG. 18 is an example embodiment of a user interface displaying a help page within a project management tool.

### DETAILED DESCRIPTION OF THE INVENTION

Set forth below are descriptions of embodiments of methods and apparatus for network-based project management. The methods and apparatus facilitate tracking project time.

Example embodiments of methods and apparatus that facilitate integrated network-based electronic reporting and workflow process management related to a Time Management Tool (TMT) are described below in detail. A technical effect produced by the methods and apparatus include, for example, facilitating tracking of project time, electronic submission of information using a client system, automated extraction of information, and web-based reporting for internal and external system users. The TMT permits a business entity to manage and track time relating to at least one project to facilitate completing projects in a cost effective and timely manner.

In the example embodiment, the TMT is utilized to collect, track, display, and disseminate real time information regarding time tracking and project information for a business entity. In addition, the TMT enables a user to track the progress of at least one project, schedule projects, and manage persons working on projects. The TMT also enables a user to generate reports relating to the tracking of project time and the status of projects. Finally, the TMT enables a user to review time tracking and project information.

Time tracking and project information is received by the TMT which stores the information in a database, updates the database with time tracking and project information received, tracks the information received, provides information in response to an inquiry, and provides a report to at least one user within the business entity relating to projects.

In one embodiment, a computer program is provided, and the program is embodied on a computer readable medium and utilizes a Structured Query Language (SQL) with a client user interface front-end for administration and a web interface for standard user input and reports. In an example embodiment, the system is web enabled and is run on a business-entity intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). In still another embodiment, the system is employed through a standalone workstation. The application is flexible and designed to run in various different environments without compromising any major functionality.

The methods and apparatus are not limited to the specific embodiments described herein. In addition, components of each apparatus and each method can be practiced independent and separate from other components and methods described herein. Each component and method can also be used in combination with other components and methods.

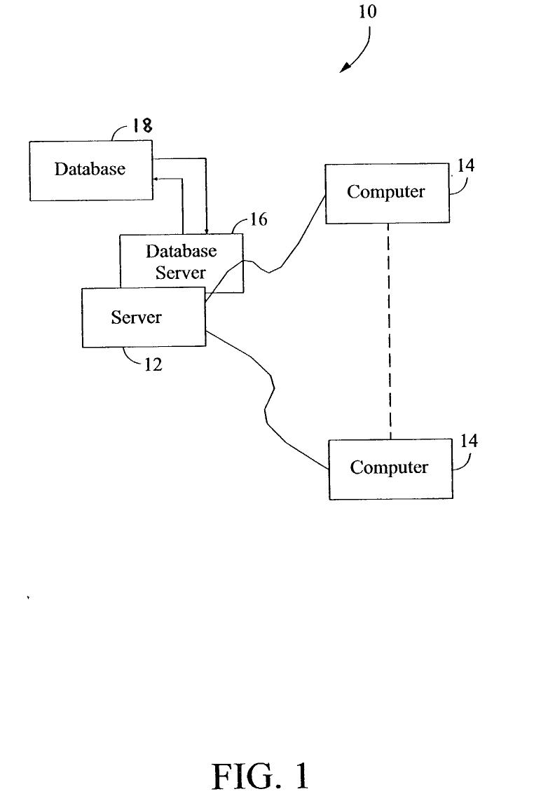

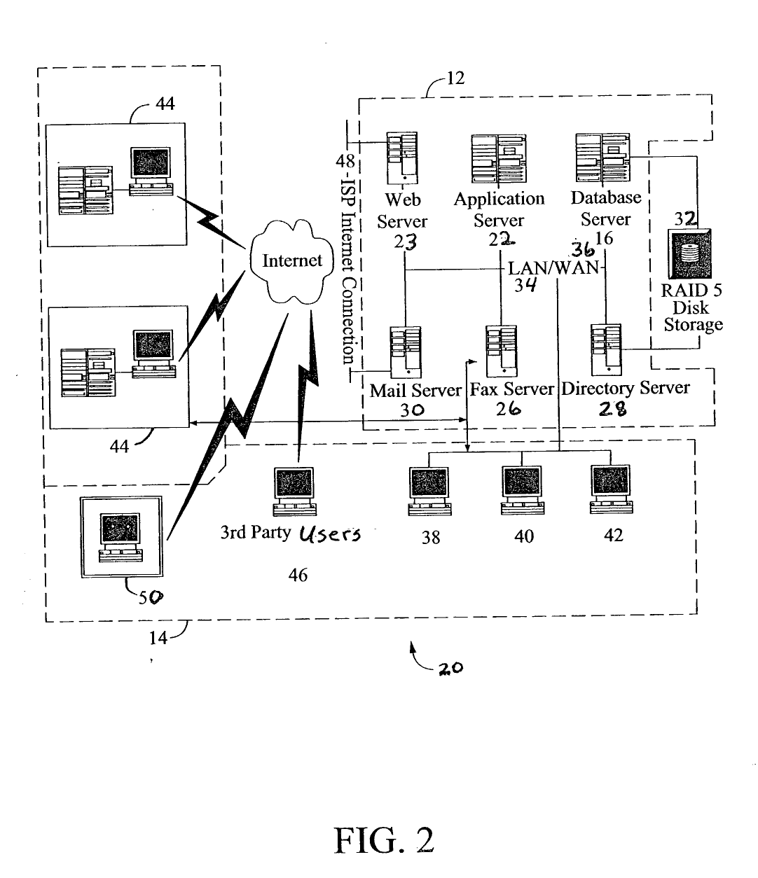

FIGS. 1 and 2 illustrate, in block diagram form, hardware architectures that can be utilized in connection with a project management tool. Of course, the system can be implemented on many different platforms and utilizing different architectures. The architectures illustrated in FIGS. 1 and 2, therefore, are examples only.

FIG. 1 is a simplified block diagram of one embodiment of a project management tool 10 for tracking project time. Tool 10 includes a server sub-system 12 and a plurality of client systems 14 connected to server sub-system 12. Client systems 14 are configured to communicate electronically with server subsystem 12. Server sub-system 12 is accessible to client systems 14 via a first network, such as a local area network (LAN), a wide area network (WAN), or the Internet. In one embodiment, client systems 14 are computers including a web browser, and server sub-system 12 is accessible to client systems 14 via the Internet. In an alternative embodiment, client systems 14 are servers for a network of customer devices. Client systems 14 are interconnected to the first network through many interfaces including a second network, such as a LAN, a WAN, or the Internet, dial-in-connections, cable modems and special high-speed ISDN lines. Client systems 14 could be any device capable of interconnecting to the first network and/or the second network, including a web-based phone or other web-based connectable equipment. Server sub-system 12 includes a database server 16 that is connected to a centralized database 18. In one embodiment, centralized database 18 is stored on database server 16. Alternatively, in another embodiment, centralized database 18 is stored remotely from server subsystem 12.

The term ‘user’, as used herein, may refer to any employee of the business entity that is authorized by the business entity to access server sub-system 12, such as project leaders, personnel managers, program leaders, process leaders, team members, including internal business entity personnel and external suppliers, or any third party authorized by the business entity to access server sub-system 12. Users access server sub-system 12 at client system 14 by logging onto server sub-system 12 through client system 14. In one embodiment, database 18 contains user names, user passwords, and user profiles. Further, and in one embodiment, users must enter a valid user name and a valid user password to access server sub-system 12. A user's access to, and ability to perform, some or all of the below described methods and other actions may be restricted or prohibited according to a user's user name, password, and profile. For example, and in one embodiment, certain of the below methods and other actions may only be performed by project leaders.

In one embodiment, server sub-system 12 is coupled to client systems 14 via a WAN, a LAN, or the Internet. A user may dial or directly log on to a WAN, a LAN, or the Internet to gain access. Each client system 14 includes an interface for communicating with server sub-system 12. The interface allows a user to input data and to receive data relating to the request. A computer-based tool for project management, as described below in more detail, is stored in server sub-system 12 and can be accessed by a user at sever system 12 or any of client systems 14.

FIG. 2 is an expanded version block diagram of one embodiment of server architecture of a project management tool 20. Components in tool 20 identical to components of tool 10 (shown in FIG. 1) are identified in FIG. 2 using the same reference numerals as used in FIG. 1. Tool 20 is configured to plan, execute, and track a plurality of projects. Tool 20 includes server sub-system 12 and a plurality of client systems 14. Server sub-system 12 includes a database server 16, an application server 22, a web server 23, a fax server 26, a directory server 28, and a mail server 30. A disk storage unit 32 incorporating a computer-readable medium is coupled to database server 16 and directory server 28. Servers 16, 22, 24, 26, 28, and 30 are coupled in a LAN 34. In an alternative embodiment, servers 16, 22, 24, 26, 28, and 30 are coupled in a WAN 36.

Client systems 14 include a system administrator workstation 38, a user workstation 40, and a supervisor workstation 42. Workstations 38, 40, and 42 are coupled to LAN 34. In an alternative embodiment, workstations 38, 40, and 42 are coupled to WAN 36. Further, in another embodiment, workstations 38, 40, and 42 are coupled to LAN 34 or WAN 36 via an Internet link or through an intranet. Each workstation 38, 40, and 42 is a personal computer having a web browser. Although the functions performed at the workstations typically are illustrated as being performed at respective workstations 38, 40, and 42, such functions can be performed at one of many personal computers coupled to LAN 34 or WAN 36. Workstations 38, 40, and 42 are illustrated as being associated with separate functions only to facilitate an understanding of the different types of functions that can be performed by individuals having access to LAN 34 or WAN 36.

In one embodiment, client systems 14 include at least one employee or individual workstation 44 and/or at least one third party user workstation 46. In one embodiment, at least one of workstations 44 and 46 are remotely located from server sub-system 12, and server sub-system 12 is configured to be communicatively coupled to workstations 44 and/or 46 via an ISP Internet connection 48. Although the communication between server sub-system 12 and workstations 44 and/or 46 is illustrated as being performed via the Internet, it will be understood that any other WAN or LAN type communication can be utilized in other embodiment, i.e., the systems and processes are not limited to being practiced via the Internet. For example, server sub-system 12 may communicate with workstations 44 and/or 46 using LAN 34 or WAN 36.

In one embodiment, any user having a client system 14 can access server sub-system 12. Further, and in one embodiment, client systems 14 include at least one workstation 50 located at a remote location, and server sub-system 12 is communicatively coupled to workstation 50 via an ISP Internet connection or a WAN. Workstations 44, 46, and 50 are personal computers having a web browser. Also, workstations 44, 46, and 50 are configured to communicate with server subsystem 12. In one embodiment, and wherein workstations 44, 46, and 50 are remotely located from server sub-system 12, fax server 26 communicates with workstations 44, 46, and 50 via a telephone link. Furthermore, in another embodiment, fax server 26 is configured to communicate with workstations 38, 40, and 42.

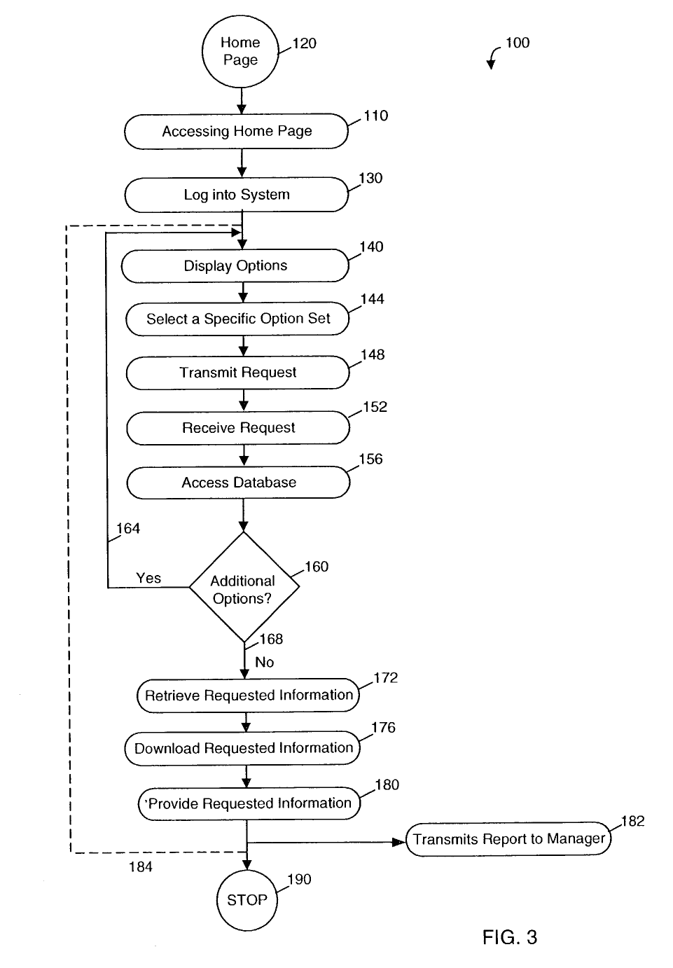

FIG. 3 is a flowchart 100 illustrating example processes utilized by project management tool 20 (shown in FIG. 2). Initially, a user accesses 110 a-user interface, such as a home page 120, of the web site through client system 14 (shown in FIG. 1). In one embodiment, client system 14, as well as server system 12, are protected from access by unauthorized individuals. The user logs-in 130 to tool 10 using a password (not shown) or an employee payroll number for security.

Client system 14 displays 140 options available to the user through links, check boxes, or pull-down lists. A technical effect of tool 20 is achieved when the user selects 144 an option (in one embodiment, relating to a business or a project within the business entity) from the available links, the request is transmitted 148 to server system 12. Transmitting 148 the request is accomplished, in one embodiment, either by click of a mouse or by a voice command. Once server system 12 (shown in FIG. 1) receives 152 the request, server system 12 accesses 156 database 20 (shown in FIG. 1). System 10 determines 160 if additional narrowing options are available. In one embodiment, additional narrowing options include project related information. If additional narrowing options are available 164, tool 10 displays 140 the options relating to the prior option selected by the user on client system 14. The user selects 144 the desired option and transmits the request 148. Server system 12 receives the request 152 and accesses 156 database 20. When tool 10 determines that additional options 160 are not available 168, tool 10 retrieves 172 requested information from database 20. The requested information is downloaded 176 and provided 180 to client system 14 from server 12. Client system 14 transmits a report 182, from a user to a manager workstation 56 (shown in FIG. 2), which summarizes the time tracking and project information. The user may continue to search 184 database 20 for other information or exit 190 from tool 10.

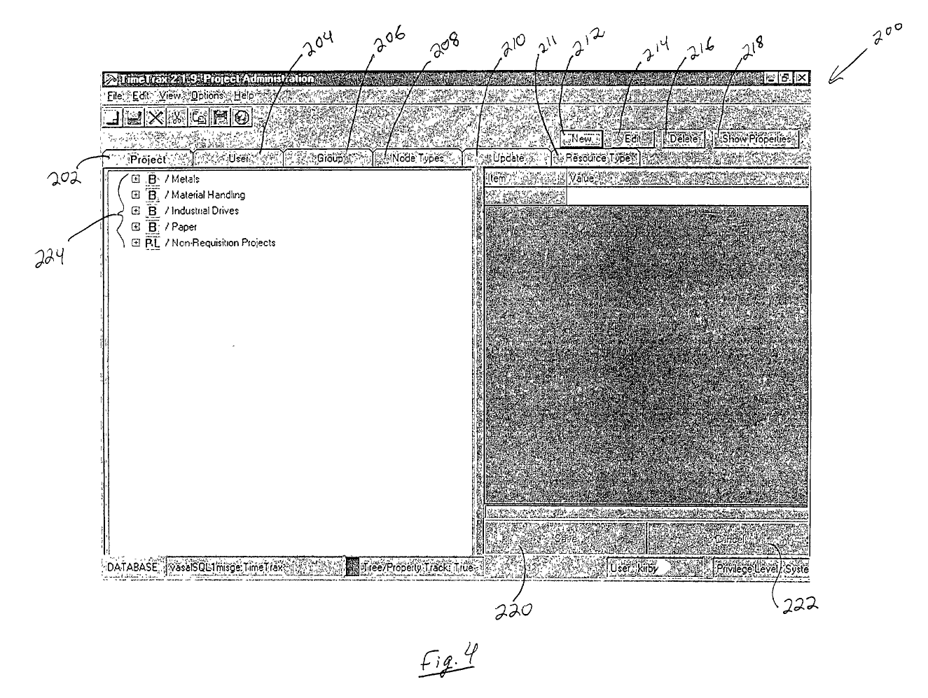

FIG. 4 is an example embodiment of a user interface 200 displaying a home page of tool 20 (shown in FIG. 2), which is displayed after a user logs into tool 20. User interface 200 displays a Project tab 202, a User tab 204, a Group tab 206, a Node Types tab 208, an Update tab 210, a Resource Type tab 211, a New button 212, an Edit button 214, a Delete button 216, a Show Properties button 218, a Save button 220, and a Cancel button 222. Project tab 202 enables a user to manage projects and tasks. User tab 204 enables a user to define and manage users within organizations. Group tab 206 enables a user to define and manage groups of users and organizations. Node Types tab 208 enables a user to define node types within tool 20. Update tab 210 enables a user to manage mail lists for notification of requisition job posting.

User interface 200 also displays a list of businesses 224 that are included in tool 20. Business List 224 is shown in a “tree-like” structure which can be expanded by a user when a specific business is clicked on by the user. Each business is displayed with a “B” icon before it.

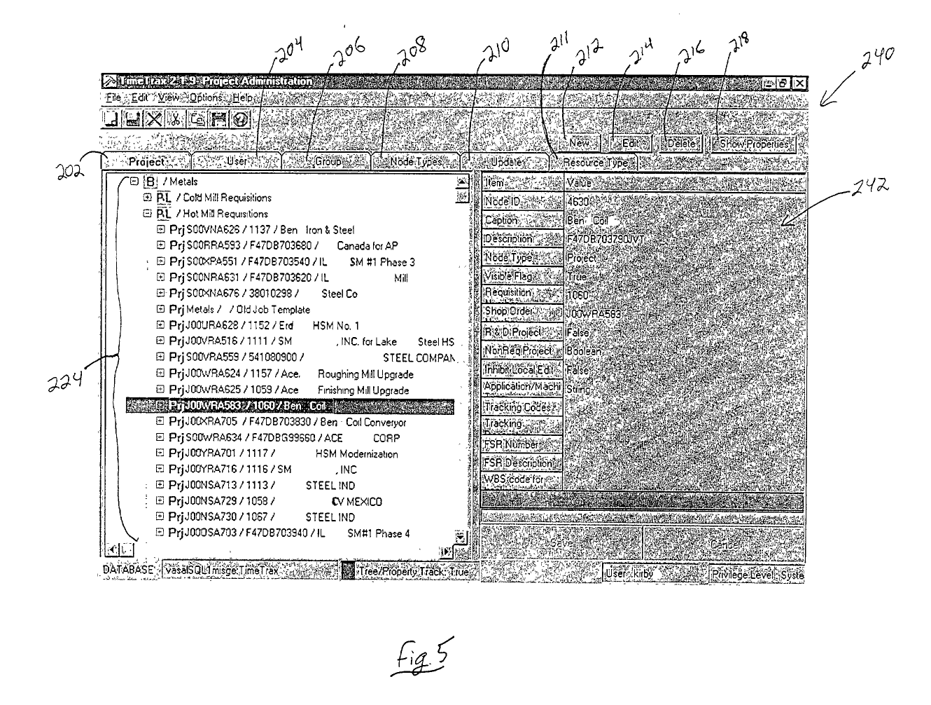

User interface 200 is an example embodiment displaying a home page within tool 20 that relates to an administration portion of tool 20. Discussed in greater detail below and shown in FIGS. 5-12 are example embodiments of user interfaces that also relate to an administration portion of tool 20. The administration portion of tool 20 enables users to utilize administrative functions included within tool 20 as well as to manage persons involved with projects.

FIG. 5 is an example embodiment of a user interface 240 displaying a project page within tool 20. User interface 240 is displayed after a user clicks on Metals within Business List 224. Metals is a Business listed within Business List 224. By selecting Metals within Business List 224, the tree-like structure is expanded to display each Business Segment included within the Metals Business. Each Business Segment is shown with a “P-L” icon before it. At least certain Business Segments can be further expanded to display Projects included with the Business Segment. Each Project is shown with a “Prj” icon before it. In the example embodiment, a Business Segment labeled “Hot Mill Requisitions” has been selected by the user such that the Projects included within this Business Segment are also displayed in the tree-like structure. Furthermore, in the example embodiment, a Project labeled “Ben Coil” has also been selected by the user such that the details relating to this specific Project are displayed in an Information window 242 that displays information relating to the Ben Coil project including at least one of Item, Node ID, Caption, Description, Node Type, Visible Flag, Requisition Number, Shop Order Number, R&D Project, NonReq Project, Inhibit Local Edit, Application/Machine Type, Tracking Codes, Tracking Description, FSR Number, FSR Description, and WBS Code for Tracking. In the example embodiment, when Show Properties button 218 is selected by the user, tool 20 displays the details for the selected node.

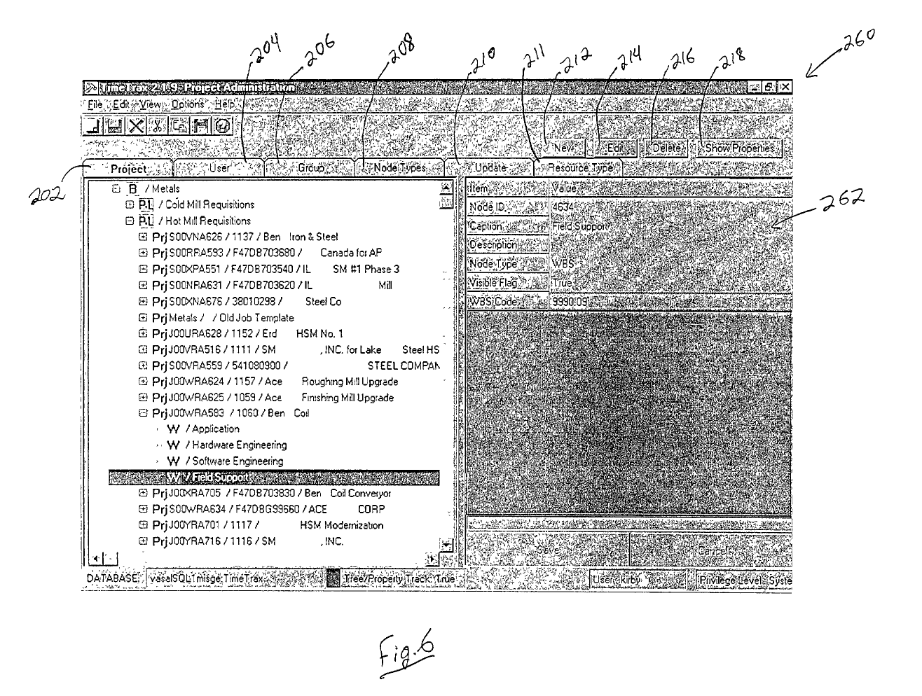

FIG. 6 is an example embodiment of a user interface 260 displaying a work page within tool 20. User interface 260 is displayed after a user selects a Project within the tree-like structure and then clicks on Show Properties button 218 as shown in user interface 240 (shown in FIG. 5). By clicking on a “+” beside the project name, the tree-like structure is further expanded to show the work breakdown below the selected Project. Each Work item is shown with a “W” icon before it. In the example embodiment, Ben Coil Project was selected such that the work breakdown related to the Ben Coil Project is displayed in the expanded tree-like structure. By selecting one of the Work items, the details relating to the selected Work item are displayed in Information window 262.

In the example embodiment, Projects displayed in the tree-like structure can be made “invisible” to the Voucher program within tool 20. In the example embodiment, red lettering indicates that Projects are invisible to the Voucher program and cannot be vouchered against, for example, while the Project is being setup, or when it is completed, or when it has been archived.

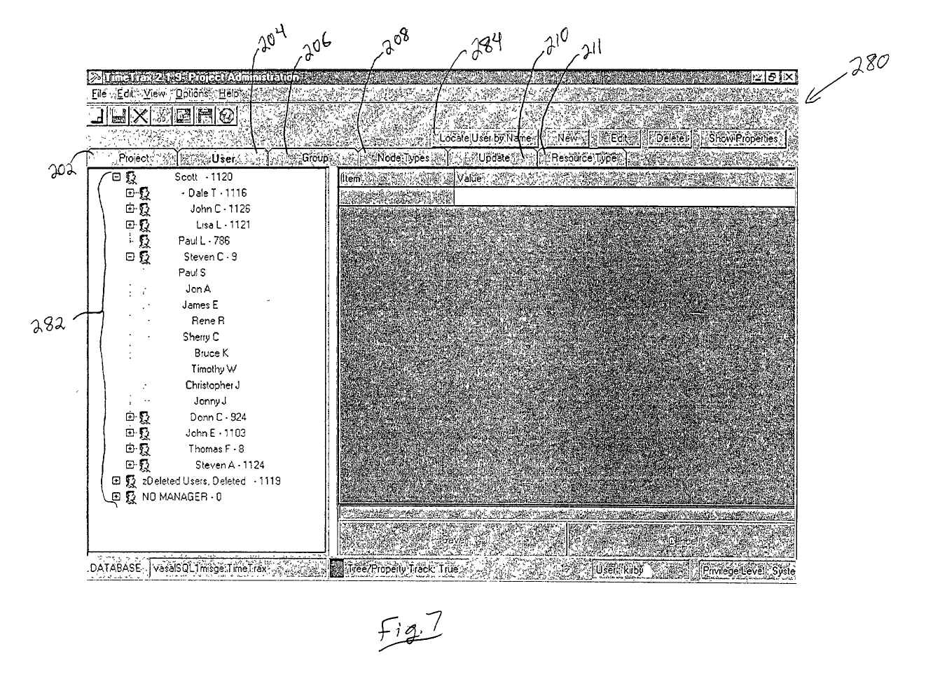

FIG. 7 is an example embodiment of a user interface 280 displaying a user page within tool 20. User interface 280 is displayed after a user selects User tab 204. User tab 204 enables a user to define and manage users within organizations. User interface 280 also displays a list of managers 282 that are included in tool 20 and displays a Locate User by Name button 284. Manager List 282 is shown in a “tree-like” structure form which can be expanded by a user when a specific manager is clicked on by the user. A “plus” icon before the name of each manager indicates that the tree-like structure can be further expanded below that particular manager to show additional persons that report to the manager. A “minus”icon before the name of a manager indicates that the tree-like structure can be collapsed to hide the people who report to the manager.

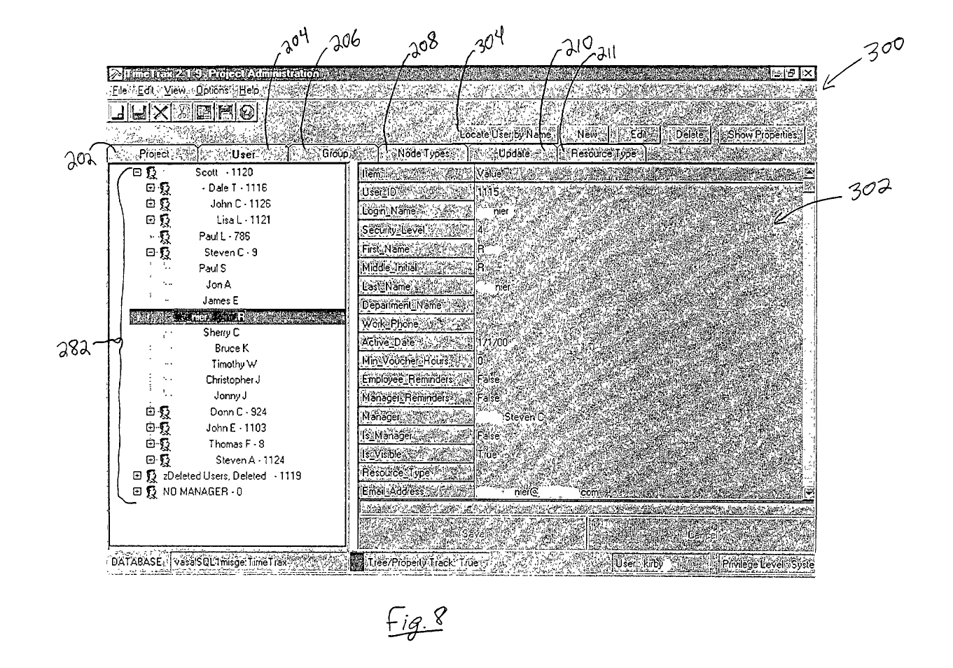

FIG. 8 is an example embodiment of a user interface 300 displaying a user page with an expanded tree-like structure within tool 20. User interface is displayed after a user selects User tab 204 and selects a manager from Manager List 282. After the user selects a specific person displayed in the tree-like structure, the information relating to the selected person is displayed in Information window 302. User interface 300 enables a user to edit information relating to a person that has already been entered into tool 20. User interface 300 also enables a user to add new persons to tool 20 and assign the newly added person to the appropriate manager. Additionally, user interface 300 enables a user to move or “drag” existing persons from one manager to another. In other words, user interface 300 enables a user to reassign an employee from one manager to another manager such that the reassignment is displayed in the tree-like structure.

In the example embodiment, user interface 300 also displays a Locate User by Name button 304. When a user clicks on Locate User by Name button 304, a pop up window is displayed listing all persons included within tool 20. The pop up window enables a user to scroll through the list to select a specific person, or a user may type in the name of the person and the person is located within the listing.

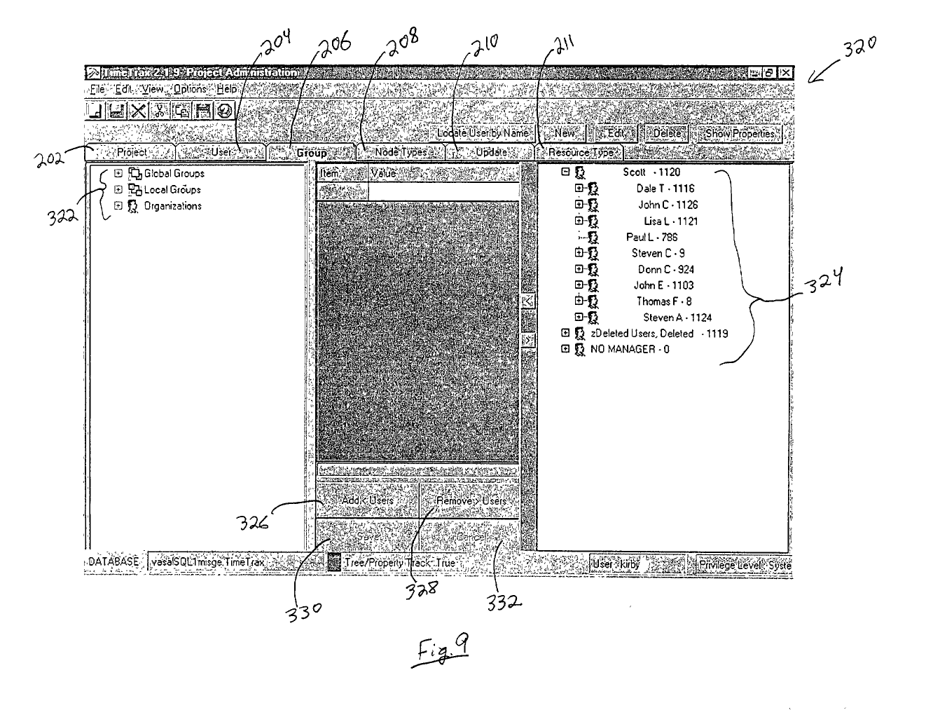

FIG. 9 is an example embodiment of a user interface 320 displaying a group page within tool 20. User interface 320 is displayed after a user selects Group tab 206. Group tab 206 enables a user to define and manage groups of users and organizations. User interface 320 displays a list of groups 322 included within tool 20. Group list 322 is shown in a “tree-like” structure which can be expanded by a user when a specific group is clicked on by the user. A “plus” icon before the name of each group indicates that the tree-like structure can be further expanded below that particular group to show additional teams and persons that are included within that particular group.

In the example embodiment, user interface 320 also displays a list of persons 324 that can be associated with a group and an organization. Person list 324 is also displayed in tree-like structure, which can be expanded to show additional persons below the listed person or collapsed to hide additional persons below the listed person. User interface further displays an Add Users button 326, a Remove Users button 328, a Save button 330, and a Cancel button 332. Add Users button 326 enables a user to add a user from Person list 324 to a group or an organization listed in Group list 322. Remove Users button 328 enables a user to remove a user from a group or an organization listed in Group list 322.

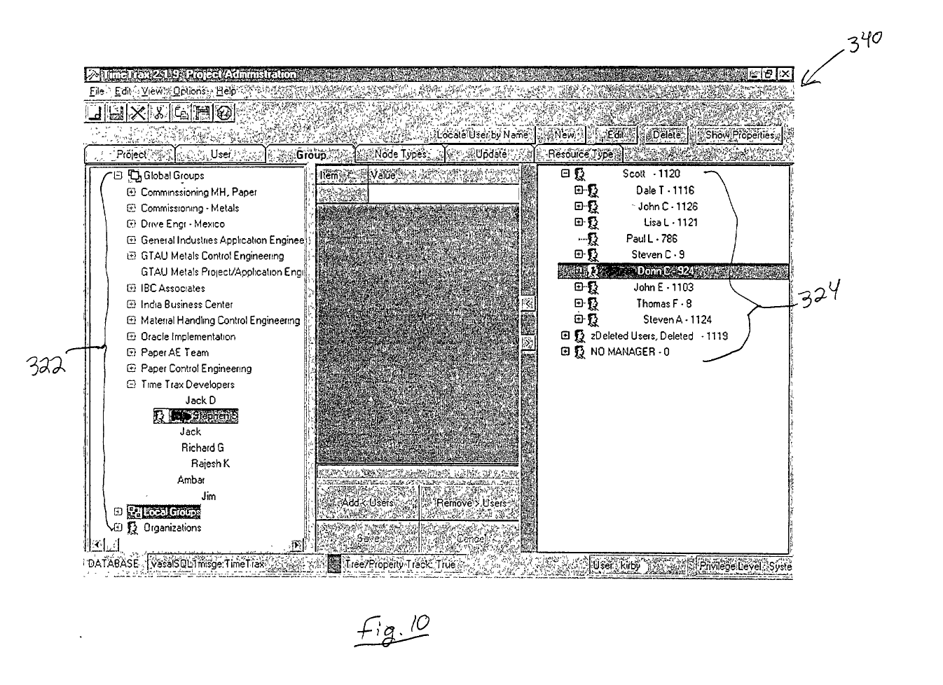

FIG. 10 is an example embodiment of a user interface 340 displaying a group page within tool 20. User interface 340 displays Group list 322, shown in a “tree-like” structure, after it has been expanded by a user to display persons included within a group. User interface 340 also displays Person list 324 after it has been expanded.

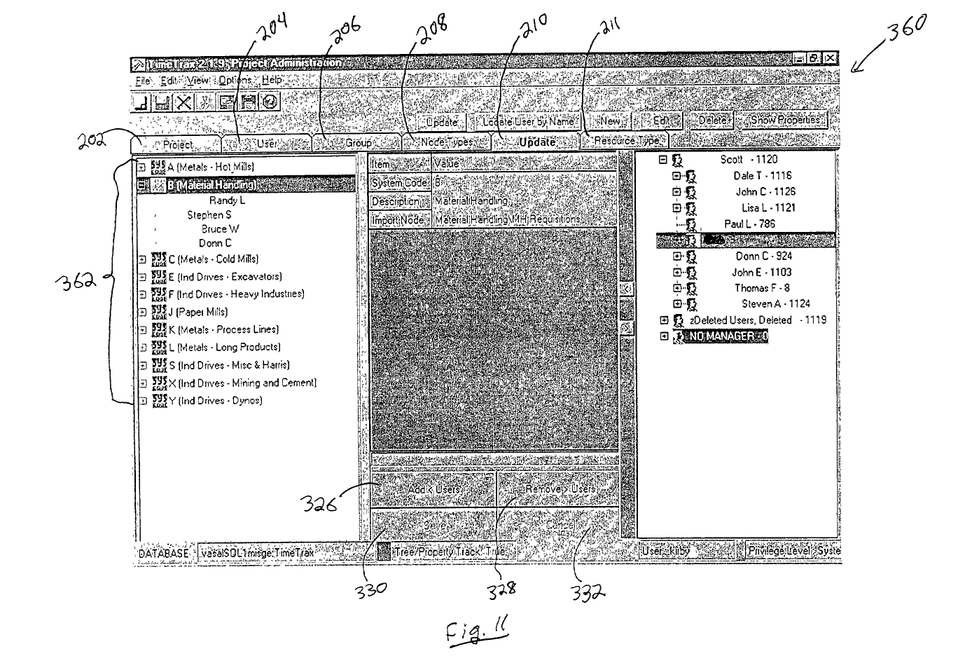

FIG. 11 is an example embodiment of a user interface 360 displaying an update page within tool 20. User interface 360 is displayed after a user selects Update tab 210. Update tab 210 enables a user to manage mail lists for notification of “new” requisition job postings. User interface 360 displays a list of Business Segments 362 within tool 20. In the example embodiment, each Business Segment is shown with a “P-L” (Profit-Loss Center) icon before it. Business Segments list 362 is shown in a “tree-like” structure which can be expanded by a user when a specific Business Segment is clicked on by the user. When clicked on, persons associated with that particular Business Segment are then displayed. User interface 360 enables a user to add or remove persons from the email notification list of new requisition postings by clicking on Add Users button 326 or Remove Users button 328, respectively, as discussed in FIG. 9.

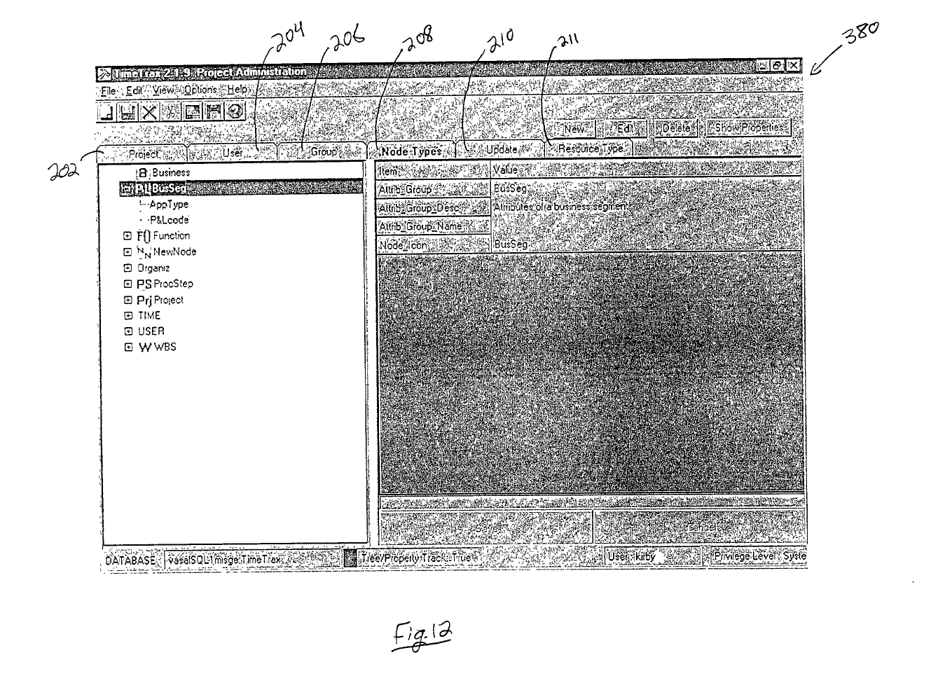

FIG. 12 is an example embodiment of a user interface 380 displaying a node types page within tool 20. User interface 380 is displayed after a user selects Node Types tab 208. Node Types tab 208 enables a user to maintain attributes and types of nodes for tool 20. Nodes include the items that form the tree. Each node has a type with certain properties. For example, the Project Node is a type of node that has data about a project, including at least one of a name, a requisition number, a shop order number, and a description.

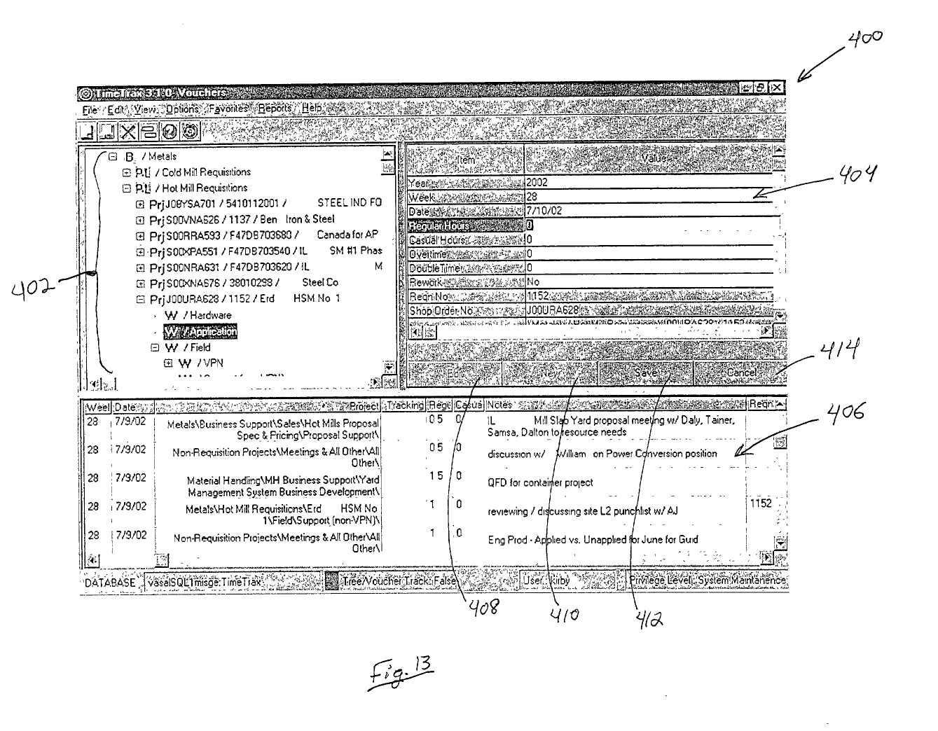

FIG. 13 is an example embodiment of a user interface 400 displaying an edit work page within tool 20. User interface 400 is displayed after a user selects a Project within the tree-like structure, selects a Work item within the tree-like structure, and then clicks on Edit button 214 (shown in FIG. 6). User interface 400 enables a user to enter and track a breakdown of time devoted to performing at least one project, and further enables the user to total and manage the project times.

More specifically, tool 20 enables a user to total a group of project time entries for a specific period of time, total a group of project time entries for a fiscal week or seven day period of time, and total a group of related project time entries for a period of time. System 20 further enables a user to report a project time entry to another user using client system 14 and the network, which includes reporting a project time entry to at least one of a project leader and a personnel manager. In the example embodiment, a project time entry includes at least one of paid hours, regular hours, overtime hours, doubletime hours, and casual hours (also referred to as non-paid hours). System 20 further enables a user to at least create, modify, maintain and report information for at least one project using client system 14, and enables a user to at least create, modify, maintain and report information for at least one user using client system 14.

User interface 400 displays an expanded Business Segment list 402 that includes certain Work items, an Edit Information window 404, and a Voucher Grid window 406. In the example embodiment, Work item “Application” within Business Segment “Hot Mill Requisitions” has been selected by the user such that the information relating to Work item “Application” is displayed in Edit Information window 404. Edit Information window 404 enables a user to edit the information relating to a particular Work item in tool 20. In the example, the user has edited the “Regular Hours” assigned to Work item “Application”.

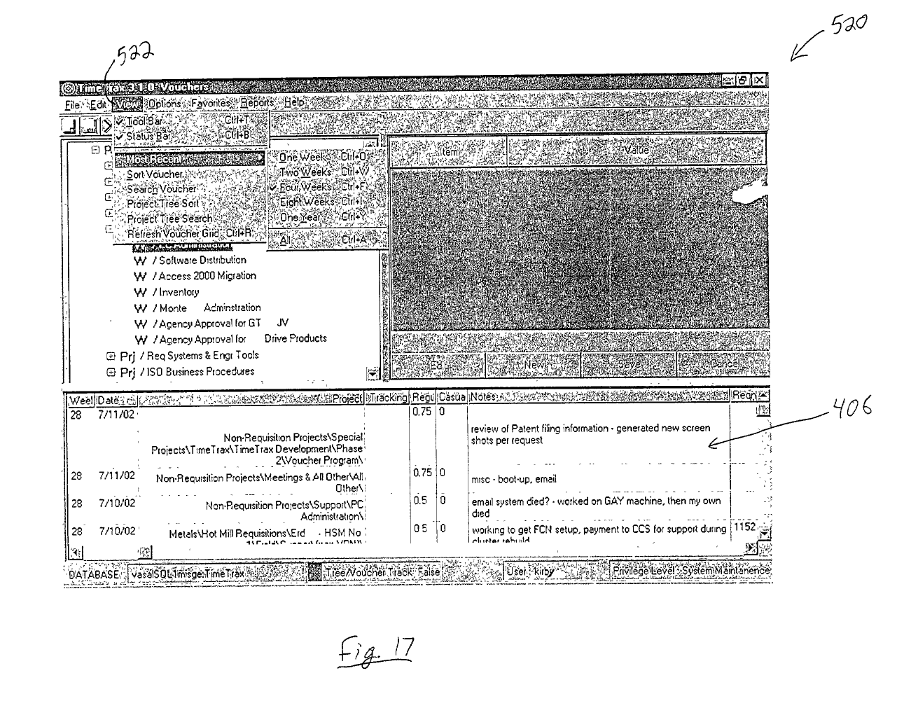

Voucher Grid window 406 displays information relating to each Project within a Business Segment. Voucher Grid window 406 is displayed in chart form and includes at least one of the following column headers: Week, Regular Hours, Casual Hours, Overtime Hours, Project, Notes, and Double Time Hours. Voucher Grid window 406 enables a user to display recent voucher entries for a plurality of time periods, including one week, two weeks, four weeks, eight weeks, and one year, as well as all voucher entries, as explained below for FIG. 17. Voucher entries are not limited to projects and can also be for absences or other non-requisition time. In the example, Voucher Grid window 406 displays the Regular Hours for the Project shown in Edit Information window 404 before the hours have been changed through Edit Information window 404.

In the example embodiment, user interface 400 also enables a user to edit notes assigned to a Project. After clicking on “Notes” within the Item column of Edit Information window 404, a pop up window (not shown) is displayed which enables a user to insert or edit notes that will be assigned to the Project. By clicking on an OK button (not shown), the Notes are saved into tool 20. User interface 400 also displays an Edit button 408, a New button 410, a Save button 412, and a Cancel button 414. Save button 412 will save edits made by the user through Edit Information window 404, while Cancel button 414 will cancel the edit session without saving any of the edits.

In the example embodiment, user interface 400 also enables a user to edit a Fiscal Week for a Voucher or a Project. After clicking on “Week” in Item column of Edit Information window 404, a pop up calendar (not shown) is displayed which enables a user to input or edit the desired Fiscal Week for the Voucher. A user may also select or record a Future Week for a Voucher by selecting a day during the Future Week and then click on a Save Future Week button. By clicking on Save button 412, the information is saved into tool 20. The future Project is then displayed in Voucher Grid window 406.

In the example embodiment, a user may also select an entry or Project from Voucher Grid window 406 for editing. The user may single click on the specific entry or Project in Voucher Grid window 406 which displays the entry in a View Mode in Edit Information window 404. The user may then edit the entry by double clicking on the specific entry to be edited within Voucher Grid window 406. The user then clicks on Save button 412 to save the changes into tool 20. In an alternative embodiment, a user may double click on the Project data field for a specific entry to bring the entire record into Edit Mode within Edit Information window 404. The user may then edit the information assigned to the Project in Edit Information window 404 as discussed above. The user then clicks on Save button 412 to save the changes into tool 20.

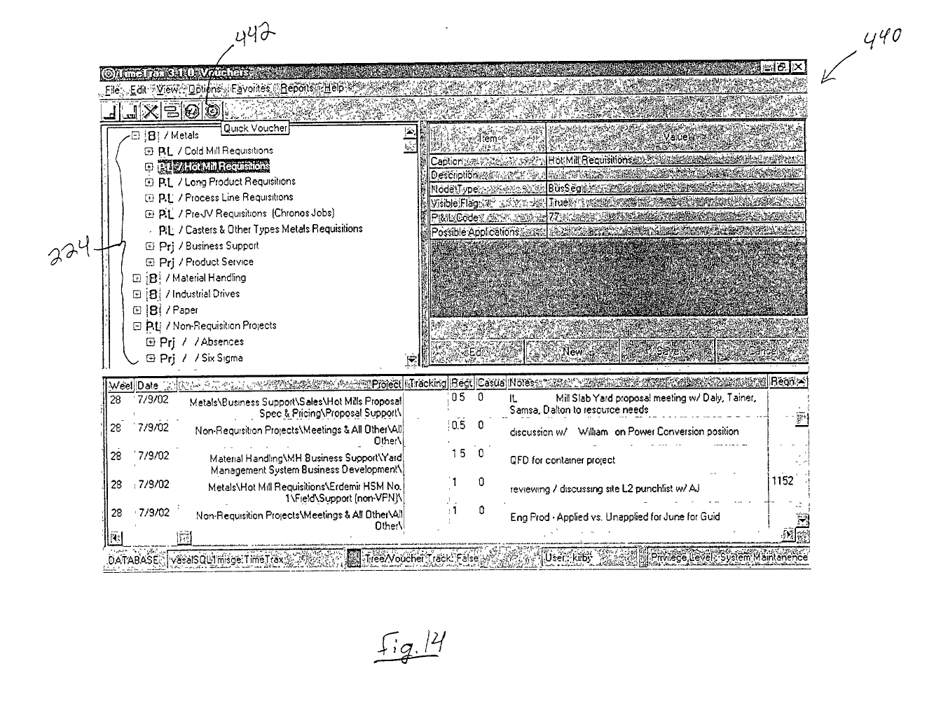

User interface 400 is an example embodiment displaying an edit work page within tool 20 that relates to a voucher portion of tool 20. Discussed in greater detail below and shown in FIGS. 14-18 are also example embodiments of user interfaces that relate to a voucher portion of tool 20. The voucher portion of tool 20 enables users to utilize voucher functions included within tool 20 including, but not limited to, managing projects, time tracking, and scheduling.

FIG. 14 is an example embodiment of a user interface 440 displaying a quick voucher page within tool 20. User interface 440 displays Business List 224 (shown in FIG. 4) in the “tree-like” structure, and a Quick Voucher icon 442. Quick Voucher icon 442 enables a user add a new voucher to tool 20. After selecting Quick Voucher icon 442, a pop up window (not shown) is displayed on user interface 440 such that a user can enter at least one of a Shop Order Number, a Requisition Number, Favorites, a Caption, and Tasks. Once entered, a user selects a New Voucher button (not shown) to enter the information into tool 20.

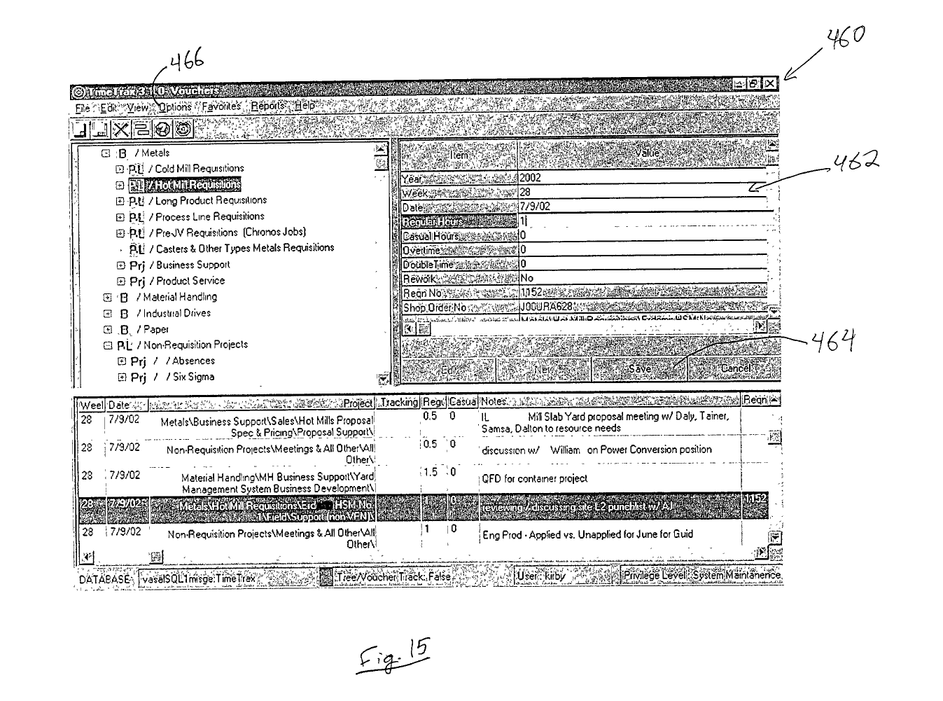

FIG. 15 is an example embodiment of a user interface 460 displaying a newly added voucher page within tool 20. After creating a new voucher within tool 20 and entering at least one of a Shop Order Number, a Requisition Number, Favorites, Caption, and Tasks, user interface 460 is displayed. User interface 460 enables a user to enter additional information through Information window 462 relating to the newly added Project including at least one of a Year, a Week, a Date, Regular Hours, Casual Hours, Overtime, Double Time, a Rework, a Requisition Number, a Shop Order Number, a Project, a Tracking Code, and Notes. Once entered, a user clicks on Save button 464 to save the newly added information.

In the example embodiment, a user may select user preferences within an Options pull-down list 466 to configure how information within tool 20 is displayed. For example, a user can select which columns are displayed and the order in which they are displayed. The user interfaces described herein are not limited to the specific embodiments described herein. Each user interface may display additional information, less information, or the same information but in different locations on the user interface.

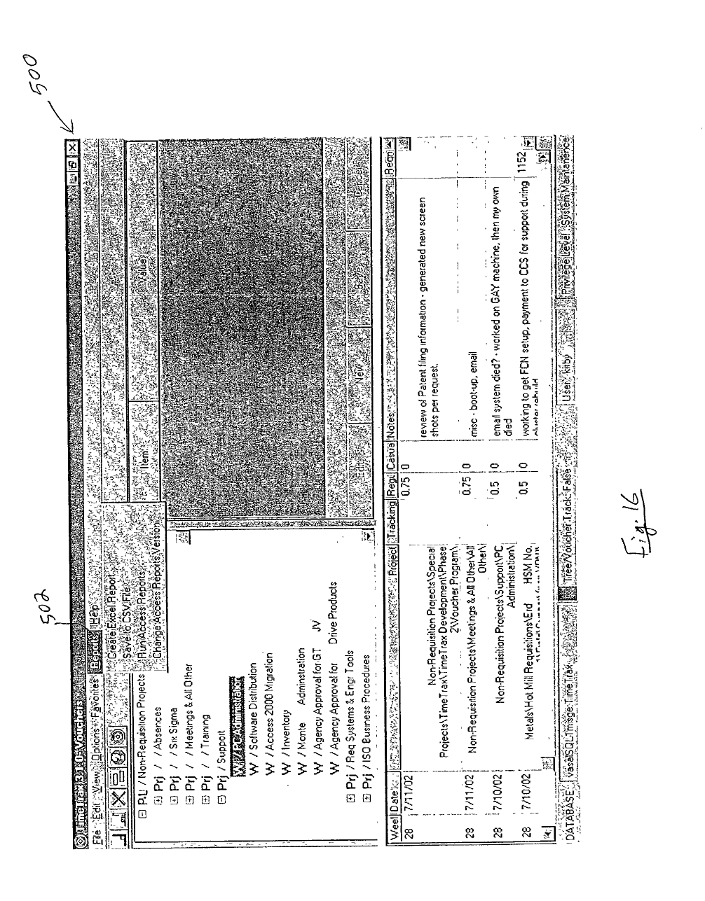

FIG. 16 is an example embodiment of a user interface 500 displaying a reports page within tool 20. User interface 500 is displayed after a user selects a Reports pull-down list 502 from a navigation bar located near the top of user interface 500. In the example embodiment, Reports pull-down list 502 includes at least one of Create Excel™ Report, Save to Comma Separated Variable (CSV) text File, and Access® Reports. (Excel and Access are trademarks of Microsoft Corporation, Redmond, Wash.) User interface 500 enables a user to export a voucher record included within tool 20 to another computer program format including, for example, an Excel computer program format, a CSV computer program format, or an Access computer program format. A user can then use the Excel, CSV, or Access file to further analyze, manage, or manipulate the voucher information.

FIG. 17 is an example embodiment of a user interface 520 displaying a view page within tool 20. User interface 520 displays a navigation bar located near the top of user interface 520 that includes a View pull-down list 522. In the example embodiment, View pull-down list 522 includes at least one of a following commands: Most Recent, Sort Voucher, Search Voucher, Project Tree Sort, Project Tree Search, and Refresh Voucher Grid. The Most Recent command includes a further pull-down list that includes at least one of One Week, Two Weeks, Four Weeks, Eight Weeks, One Year, and All. The Most Recent command enables a user to select the number of vouchers that are displayed in Voucher Grid window 406.

In the example embodiment, user interface 520 also enables a user to sort and search for vouchers or projects. For example, to search for a voucher, a user may select the Search Voucher command included within View 522 pull-down list, which causes a pop up window to be displayed in user interface 520. The pop up window includes a Field pull-down list (not shown), a Search For Data field (not shown), an OK button (not shown), and a Quit button (not shown). The pop up window prompts a user to enter data that will be used by tool 20 to perform a search within tool 20. In the example embodiment, the results of the search are displayed in Voucher Grid window 406. A user can then review the results of the search as displayed in Voucher Grid window 406 to determine which voucher or vouchers are of interest to the user.

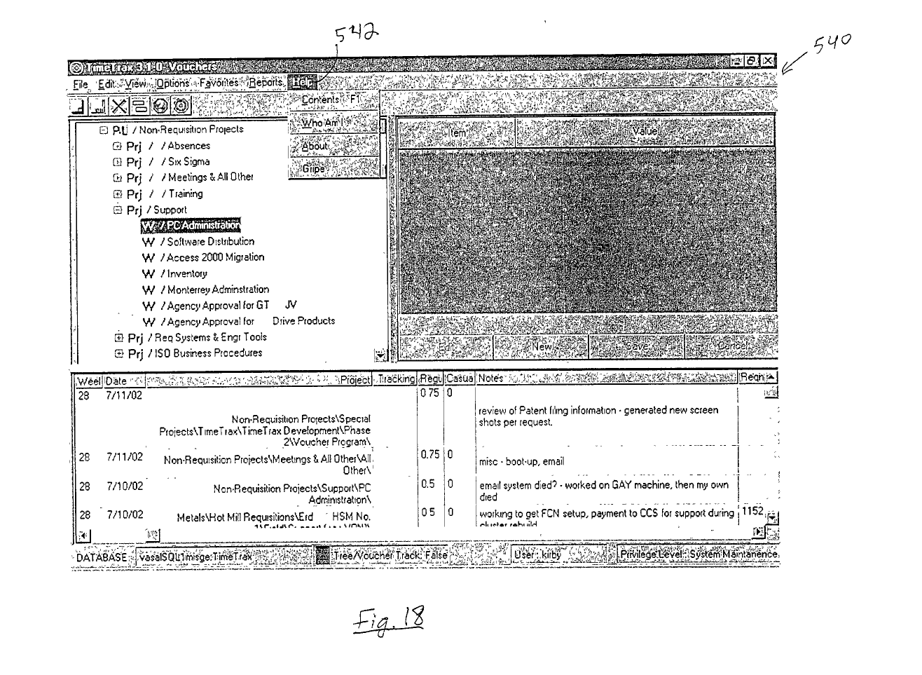

FIG. 18 is an example embodiment of a user interface 540 displaying a help page within tool 20. User interface 540 displays a navigation bar located near the top of user interface 540 that includes a Help pull-down list 542. In the example embodiment, Help pull-down list 542 includes at least one of the commands Contents, Who Am I, About, and Gripe. In the example embodiment, Help pull-down list 542 enables a user to select from a plurality of help contents and access on-line help information relating to tool 20. A user may also view identifying information stored in tool 20 to determine whether the information is accurate or requires editing. Also, Help pull-down list 542 enables a user to “gripe” or send an electronic message to a system administrator, advising the system administrator of a complaint or concern the user might have with respect to tool 20.

Time Management Tool (TMT) 20 therefore enables a business entity to facilitate tracking of project time, electronic submission of information using a client system, automated extraction of information, and web-based reporting for internal and external system users. TMT 20 enables a business entity to collect, track, display, and disseminate real time information regarding time tracking and project information. Additionally, TMT 20 enables a user to track the progress of at least one project, schedule projects, manage persons working on projects, and generate reports relating to the tracking of project time and the status of the projects. TMT 20 also enables a business entity to review and analyze time tracking and project information. By enabling a business entity to better track time and manage projects, TMT 20 facilitates reducing project costs and facilitates reducing the amount of time spent on each project by the business entity such that each project may be completed in a cost effective and timely manner.

While the invention has been described in terms of various specific embodiments, those skilled in the art will recognize that the invention can be practiced with modification within the spirit and scope of the claims.

What is claimed is:

1. A method for project management using a project management tool and a network, the project management tool including a database and at least one client system, wherein the at least one client system is configured to communicate with the network and the project management tool, said method comprising:
entering a project time entry into the database using the at least one client system and the network;
storing the project time entry in the database; and
allowing a user to at least one of view, modify, delete, and report the project time entry using the at least one client system and the network.

2. A method in accordance with claim 1 further comprising displaying at least one project stored in the database on the client system using a “tree-like” structure format.

3. A method in accordance with claim 1 further comprising displaying at least one of a person and at least one of a group of persons associated with a project on the client system using a “tree-like” structure format.

4. A method in accordance with claim 1 further comprising displaying multiple views of the project time entry on the client system using the network and the project management tool.

5. A method in accordance with claim 1 further comprising summing a group of project time entries for a period of time.

6. A method in accordance with claim 5 wherein summing a group of project time entries for a period of time comprises summing a group of project time entries for a time period of seven days.

7. A method in accordance with claim 5 wherein summing a group of project time entries for a period of time comprises summing a group of related project time entries for a period of time.

8. A method in accordance with claim 1 further comprising allowing a user to report a project time entry to another user using the client system and the network.

9. A method in accordance with claim 8 wherein allowing a user to report a project time entry to another user using the client system and the network comprises allowing a user to report a project time entry to at least one of a project leader and a personnel manager.

10. A method in accordance with claim 1 wherein the project time entry comprises at least one of paid hours, non-paid hours, regular hours, overtime hours, doubletime hours, and casual hours.

11. A method in accordance with claim 1 further comprising tracking costs for the number of hours in the at least one project time entry using the project management tool.

12. A method in accordance with claim 1 further comprising allowing a user to at least one of create, modify, maintain and report information for at least one project using the client system, the project management tool, and the network.

13. A method in accordance with claim 1 further comprising allowing a user to at least one of create, modify, maintain and report information for at least one user using the client system, the project management tool, and the network.

14. A method in accordance with claim 1 further comprising connecting the at least one client system and the project management tool via the network, wherein the network includes one of a wide area network, a local area network, an intranet and the Internet.

15. A project management apparatus comprising:
at least one computer configured as a server, said server containing a centralized database;
at least one client system connected to said server through a network, said client system configured with a browser;
said centralized database containing at least one project time entry;
said server configured to:
store said at least one project time entry in said database; and
allow a user to at least one of view, modify, delete, and report said at least one project time entry using said at least one client system and said network.

16. An apparatus in accordance with claim 15 wherein said server further configured to display at least one project stored in said database on said client system using a “tree-like” structure format.

17. An apparatus in accordance with claim 15 wherein said server further configured to display at least one of a person and at least one of a group of persons associated with a project on said client system using a “tree-like” structure format.

18. An apparatus in accordance with claim 15 wherein said server further configured to display multiple views of said at least one project time entry on said client system using said network and said project management system.

19. An apparatus in accordance with claim 15 wherein said server further configured to sum a group of project time entries for a period of time.

20. An apparatus in accordance with claim 15 wherein said server further configured to sum a group of project time entries for a time period of seven days.

21. An apparatus in accordance with claim 15 wherein said server further configured to sum a group of related project time entries for a period of time.

22. An apparatus in accordance with claim 15 wherein said server further configured to allow a user to report said at least one project time entry to another user using said client system and said network.

23. An apparatus in accordance with claim 22 wherein said server further configured to allow a user to report said at least one project time entry to at least one of a project leader and a personnel manager.

24. An apparatus in accordance with claim 15 wherein said at least one project time entry comprises at least one of paid hours, non-paid hours, regular hours, overtime hours, doubletime hours, and casual hours.

25. An apparatus in accordance with claim 15 wherein said server further configured to track costs for the number of hours in said at least one project time entry.

26. An apparatus in accordance with claim 15 wherein said server further configured to allow a user to at least one of create, modify, maintain and report information for at least one project using said client system, said project management tool, and said network.

27. An apparatus in accordance with claim 15 wherein said server further configured to allow a user to at least one of create, modify, maintain and report information for at least one user using said client system, said project management tool, and said network.

28. An apparatus in accordance with claim 15 wherein said server and said at least one client system are connected through a network that includes one of a wide area network, a local area network, an intranet and the Internet.

29. A computer program embodied on a computer readable medium for managing projects, said program comprising a code segment that:
maintains a database by adding, deleting and updating information relating to at least one project;
stores at least one project time entry in said database; and
enables a user to at least one of view, modify, delete, and report said at least one project time entry through a client system.

30. A program in accordance with claim 29 wherein said code segment is further configured to display at least one project stored in said database on said client system using a “tree-like” structure format.

31. A program in accordance with claim 29 wherein said code segment is further configured to display at least one of a person and at least one of a group of persons associated with a project on said client system using a “tree-like” structure format.

32. A program in accordance with claim 29 wherein said code segment is further configured to display multiple views of said at least one project time entry on said client system.

33. A program in accordance with claim 29 wherein said code segment is further configured to:
sum a group of project time entries for a period of time;
sum a group of project time entries for a time period of seven days; and
sum a group of related project time entries for a period of time.

34. A program in accordance with claim 29 wherein said code segment is further configured to:
generate a report relating to said at least one project time entry and transmit said report to another user; and
generate a report relating to said at least one project time entry and transmit said report to at least one of a project leader and a personnel manager.

35. A program in accordance with claim 29 wherein said code segment is further configured to track time relating to at least one project including at least one of paid hours, non-paid hours, regular hours, overtime hours, doubletime hours, and casual hours.

36. A program in accordance with claim 29 wherein said code segment is further configured to track costs for a number of hours in said at least one project time entry.

37. A program in accordance with claim 29 wherein said code segment is further configured to create, modify, maintain and report information for at least one project.
